(19) United States
(12) Patent Application Publication
(10) Pub. No.: US 2004/0246353 A1
(43) Pub. Date: Dec. 9, 2004

(54) Method of accelerating the speed of scanning an image that does not occupy an entire CCD strip of cells

(75) Inventor: Patrice Lavergne, Monteynard (FR)

Correspondence Address: HESLIN ROTHENBERG FARLEY & MESITI PC, 5 COLUMBIA CIRCLE, ALBANY, NY, 12203, US

(73) Assignee: KIS, Echirolles (FR)

(21) Appl. No.: 10/888,491

(22) Filed: Jul. 9, 2004

Related U.S. Application Data
(63) Continuation of application No. PCT/FR03/00364, filed on Feb. 5, 2003.

(30) Foreign Application Priority Data
Feb. 5, 2002 (FR) 02.01452

(51) Int. Cl. H04N 5/335

(52) U.S. Cl. 348/294

(57) ABSTRACT

A method of accelerating the speed of scanning an image that does not occupy an entire CCD strip of cells comprises: centering the image on the strip such that the non-used area of said strip is distributed on either side of the effective area, reducing, e.g., by masking, the light intensity in the non-used areas of the strip, such that, with each cycle, the charge stored by the storage capacitors is less than half of the available capacity; and, with each cycle, reading a number of cells that is equal to that of the sum of the cells in the effective area and those from one of the two lateral areas. The method is suitable for use in scanning film images that can take various formats.

The present invention relates to a method for accelerating the rate of analysis by scanning of an image that does not occupy all of a linear array of CCD cells. It applies in particular, but not exclusively, to the analysis by scanning of film images which may have a plurality of formats, by means of an optoelectronic assembly with a fixed objective which involves, on the one hand, a light source illuminating a region of the image of the film and, on other hand, the objective that projects the region of this image onto a linear array of CCD cells.

The optoelectronic assembly is designed so that, for the largest film format, the image of the illuminated region occupies the full length of the linear array of CCD cells.

It is clear that when changing to smaller film formats, the image of the illuminated region of the film will then occupy only a fraction of the linear array of CCD cells.

Under these conditions, reading all of the linear array of CCD cells leads to a non-negligible time wastage, which is proportional to the unuseful part of the linear array.

Now in order to avoid this time wastage, and therefore shorten the reading time, the solution which the person skilled in the art may envisage is to read only the useful part of the CCD linear array, given that the reading time is a function of the number of cells that are read.

In fact, this solution leads to many difficulties and has been rejected to date.

This is because when the linear CCD array is exposed to the image produced by the objective, each light-sensitive element or photosite generates electric charges which are transferred into storage capacitors, favoring their collection before they are transferred to the reading component. Placed in front of the storage sites, a charge transfer register is provided in order to transfer the charge packets to the output component. This shift register acts as a parallel/series multiplexer and sequentially delivers each packet of charges to the reading component.

In each reading cycle of the charge transfer register, the electric charges are thus transferred from the storage capacitors to the charge transfer register; the storage capacitors discharged in this way then are ready to receive the electric charges of the next cycle.

However, if a region of the linear array is not read during a reading cycle of the register, then the storage capacitors corresponding to this region will keep their initial charges. They will consequently accumulate these initial charges with new charges transferred during the next cycle; repetition of this process leads to saturation of the storage capacitors and runs the risk of creating an overflow of the excess charges to the neighboring cells.

In video images, the effect of this phenomenon referred to as dazzle is to white-out the regions lying immediately in the vicinity of the bright points.

It is therefore more particularly an object of the invention to eliminate this drawback, so as to make it possible to accelerate the reading when the image projected onto the linear array of CCD cells does not occupy the full length of this linear array.

To that end, a method is provided for accelerating the rate of analysis by scanning of an image that does not occupy all of a linear array of CCD cells; which method involves:

centering the image on the linear array, so that the unused region of the array is distributed on either side of the useful region,

reducing, for example by masking, the light intensity in the unused regions of the linear array, so that the charge stored by the storage capacitors in each cycle is less than half of the available capacity,

in each cycle, reading a number of cells equal to that of the sum of the cells of the useful part and those of one of the two lateral regions,

under these conditions:

let ZU be the number of cells of the useful region,

let ZA be the number of cells of the lateral region A,

let ZB be the number of cells of the lateral region B,

let ZT be the total number of cells in the linear array,

let G be the saving in reading time.

The number of unread cells of the region A is equal to:

ZA=0.5(ZT−ZU)

The saving in reading time is equal to:

G=k.ZT/(ZU +ZA)

k is a coefficient associated with the structure of the linear array.

The means for centering the image on the linear array of CCD cells may for example include:

a device for initially reading all of the linear cell array,

a device for storing the reading signal,

position slaving of the linear array in the image focal plane.

The position slaving, based on the stored initial reading signal, positions the linear array so that the useful region is centered.

The means for reducing the image by masking may in turn comprise:

a device for ascertaining the film format to be processed,

a library of predefined masks,

a device for picking a mask up and putting it in place.

When the film to be processed is introduced, the film format is transmitted to the mask placement device, which selects the mask corresponding to the film format from the library of masks and places it close to the linear array of cells.

Other means for reducing the image may be used, such as a diaphragm with sectors whose opening is controlled by the information about the type of film to be processed; this diaphragm is placed close to the linear array of cells.

The two examples of means described above necessitate prior centering of the useful region on a linear array of cells.

The means for reading in each cycle are of the conventional type, and are determined by the reading rate and the dynamic range of the output signal of the transfer registers.

Embodiments of the invention are described below by way of nonlimiting examples with reference to the appended drawings, in which:

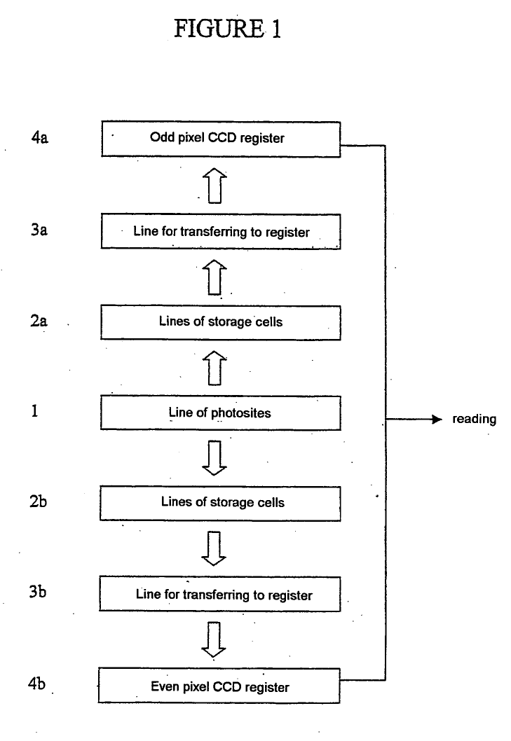

FIG. 1 represents the diagram of a linear array of CCD cells comprising a line of photosites associated with charge storage cells;

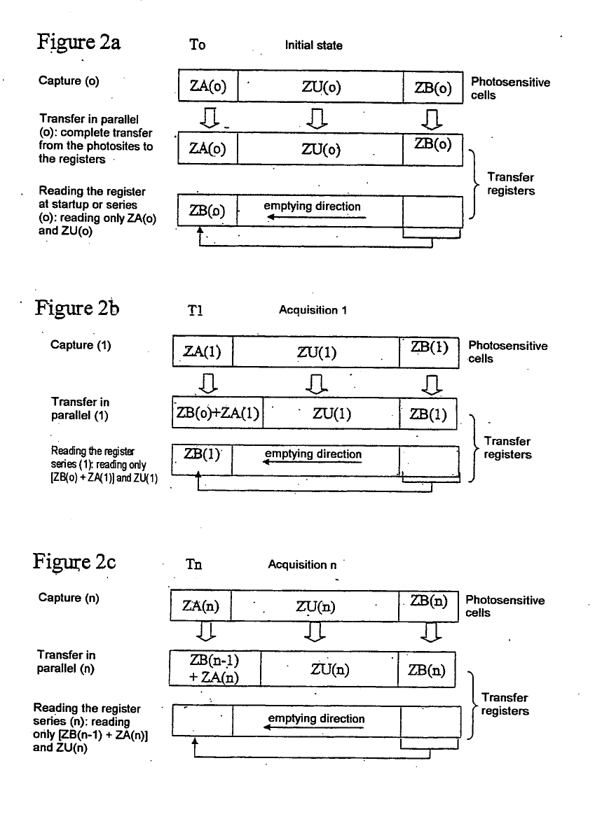

FIGS. 2a to 2c represent the mechanism for partial reading of the linear array of CCD cells at the time T0 (FIG. 2a), at the time T1 (FIG. 2b) and at the time Tn (FIG. 2c);

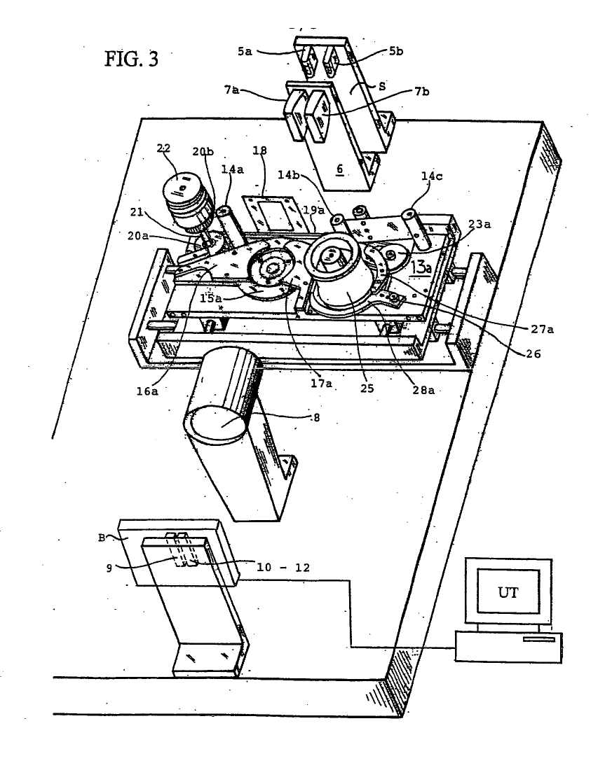

FIG. 3 is the representation of an example of a device that uses the method according to the invention.

FIG. 1 schematically shows the structure of a linear array of CCD cells; it essentially consists of a central line of photosites that are sensitive to the incident light.

On either side of this line of photosites, lines are placed that process the information provided by the photosites while separating the destinations toward the even and odd constituent pixels of the image read by the linear array. This processing is thus carried out by means of lines of storage cells and lines for transfer to the associated registers.

According to the diagram in FIG. 1, the image is captured by the line of photosites, 1 which generate electric charges that are stored in the adjacent lines of storage cells 2a and 2b, which transfer their charges to the registers 4a and 4b by means of the transfer lines 3a and 3b.

Transfer of the charges emitted by the photosites to the registers 4a and 4b is referred to as an “emptying” operation.

Reading of the transfer registers 4a and 4b is referred to as a “reading” operation.

FIGS. 2a, 2b and 2c represent the state of the line of photosites or photosensitive cells, and the state of the associated transfer register, at different times corresponding to the three steps: initial state, index “1” acquisition and index “n” acquisition. The transfer register is represented by the level of the charges provided-by the line of photosites, and by the symbolic of its reading process.

The distribution of the charges in the three regions, corresponding to the useful region and to the two lateral regions, is indicated in each of the steps.

According to FIGS. 2a to 2c, the mechanism for partial reading of the linear CCD cell array according to the invention is as follows:

let ZU(n) be the level of charge of the storage capacitors associated with the photosites of the useful region having ZU cells, during the reading cycle of index n,

let ZA(n) be the level of charge of the storage capacitors associated with the photosites of the first lateral region having ZA cells, during the reading cycle of index n,

let ZB(n) be the level of charge of the storage capacitors associated with the photosites of the second lateral region having ZB cells, during the reading cycle of index n,

let T(n) be the cycle of index n,

if n=0: T=To initial cycle,

if n=1: T=T1 first cycle.

During the initial cycle To (FIG. 2a), the states of the charges of the cells are respectively ZU(o), ZA(o) and ZB(o).

During the operation of “emptying” the cells, which is carried out firstly via the first lateral region having ZA cells, then the useful region having ZU cells, the second lateral region is not affected.

At the end of the initial cycle To, the charges of the second lateral region not read during the “reading” operation will become transferred into the transfer line of the first lateral region.

During the first cycle T1 (FIG. 2b), the cells of the useful region and of the lateral regions are again charged by the corresponding photosites.

The operation of “emptying” the cells is carried out in a way equivalent to that above.

At the end of the cycle T1, during the “reading” operation,

the level of the charges read in the first lateral region is equal to:

ZB(o)+ZA(1)

the level of the charges read in the useful region is equal to:

ZU(1).

Thus during the cycle n (FIG. 2c) corresponding to the end of the analysis by scanning of the image of the film:

the level of the charges read in the first lateral region is equal to:

ZB(n−1)+ZA(n)

the level of the charges read in the useful region is equal to:

ZU(n).

It can therefore be seen that in each cycle, the cells of the useful region and of the second lateral region are emptied and cannot therefore be involved in a dazzle phenomenon, while the charges read in the first lateral region are equal to the sum of the charges transmitted by the photosites of the two lateral regions.

It is therefore sufficient to operate in such a way that the sum of the charges transmitted by the photosites of the two lateral regions is less, for each cycle in question, than the storage capacity of the storage cells of the first lateral region.

By virtue of these provisions, it is possible to obtain time savings of the order of 30 to 40% for the smallest formats.

FIG. 3 illustrates a representation of a device that uses the method according to the invention, various elements of the device being fixed on a support, namely:

a support S having the two separate light sources 5a, 5b side by side,

a support 6 for the two light guides/conditioners 7a, 7b, each being positioned in front of one of the light sources,

a device for guiding a film,

an objective 8 for beams provided respectively by the sources 5a, 5b,

a support having a case B provided with openings (which are not represented in FIG. 3), this case comprising linear arrays of infrared CCDs 9 and RGB CCDs 10-12 located in front of the openings, position slaving of the linear arrays (which is not represented in FIG. 3) and a device for picking a mask up and putting it in place (which is not represented in FIG. 3), connected to a processing unit UT.

The supports of the sources, the guides and the CCD linear arrays and the objective extend along the same axis.

The device for guiding the film is interposed between the guides and the objective.

The structure of the device for guiding a film has two parallel metal panels, only one 13a of which is represented, which are separated by three struts 14a, 14b, 14c arranged along the upper side of the panels. These various elements constitute a rigid constituent assembly of the device for guiding a film. The distance which separates two metal panels 13a, 13b is slightly greater than the width of the film to be analyzed.

The device for guiding the film comprises two coaxial parallel rollers in an imaging region, only one 15a of which is represented, which are mounted so as to rotate with the aid of ball bearings and are held by backing plates, of which one pair of backing plates 16a, 17a is represented. The side edges of the film bear respectively on the two rollers 15a and 15b, along a circle arc so that the film follows a circular path. Along this circular path, it thus has a cylindrical shape with a rectilinear generatrix. This position makes it possible, in the imaging region, to obtain a view of the transverse rectilinear region level with which a slot is arranged, the latter being made in a plate 18 secured to the two panels 13a and 13b and forming a rectangular space for delivery of the beams emitted by the assemblies located on the outer side of the plate 18 and comprising the light sources 5a, 5b/light guides 7a, 7b.

The device for driving the film comprises two parallel belts, only one 19a of which is represented, which advance synchronously and which respectively bear on the side edges of the film 1 level with its circular path over the rollers, only one 15a of which is represented. Frictional driving of the two side edges of the film is thus obtained, which eliminates any possibility of a speed variation between these two edges. The two belts, only one 19a of which is represented, have notches on the opposite side to the film, the belts being driven by means of two coaxial notched pulleys 20a and 20b, the common spindle 21 of which is driven by an electric motor 22, and two free notched pulleys, only one 23a of which is represented. The two belts, only one 19a of which is represented, are tensioned and positioned by rollers which are not represented in the figure.

The device for spooling the film consists of a diabolo-shaped roller 25 mounted so as to rotate about a spindle 26 parallel to the spindle of the rollers, with return by a spring. This spindle is guided so that it can be moved along an oblong orifice as a function of the thickness of the film spooled on the roller 25. The principal axis of the oblong orifice is oriented perpendicular to the tangent plane of application of the belts on the edges of the film (application force collinear with the principal axis of the oblong hole). Two pairs of arms, of which only one pair 27a and 28a is represented, guide the film when it is being introduced or extracted around the diabolo-shaped roller 25. The arms, only one 27a of which is represented, are articulated. It can therefore be seen that the angular velocity of the diabolo, which does not have its own drive means, is a function of the spooling level of the film.

The film introduction region comprises a light source/detector assembly located on either side of the film and intended for reading barcodes located at the border of the film so that, on the one hand, it is possible to identify the film and, on the other hand, it is possible to check that it has been inserted the correct way round.

1. A method for accelerating the rate of analysis by scanning of an image that does not occupy all of a linear array of CCD cells, including:
centering the image on the linear array so that an unused lateral region A and an unused lateral region B of the array is are distributed respectively, on either side of a useful region,
reducing the light intensity in the unused lateral regions of the linear array, so that charge stored by storage capacitors in each cycle is less than half of available capacity, and
in each cycle, reading a number of cells equal to that of the sum of the cells of the useful region and those of one of the unused lateral regions.

2. The method as claimed in claim 1, wherein unused lateral region B comprises said one of the unused lateral regions and the number of unread cells of the region A is equal to:
ZA=0.5(ZT−ZU)
where ZU is number of cells of the useful region,
ZA is number of cells of the lateral region A,
ZB is number of cells of the lateral region B,
ZT is total number of cells in the linear array.

3. The method as claimed in claim 2, wherein a saving in reading time G is realized equal to:
G=k.ZT/(ZU+ZA)
where k is a coefficient associated with the a structure of the linear array.

4. The method as claimed in claim 1, wherein the cells of the useful region and of a second of the unused lateral regions are emptied in each reading cycle.

5. The method as claimed in claim 4, wherein in each cycle, charges read in the one of the unused lateral regions are equal to a sum of charges transmitted by photosites of the unused lateral regions.

6. The method as claimed in claim 1, wherein the light intensity in the unused lateral regions is reduced by masking.
